(19) United States
(12) Patent Application Publication
(10) Pub. No.: US 2012/0042536 A1
(43) Pub. Date: Feb. 23, 2012

(54) Dryer

(76) Inventor: Jeffrey C. White, Katy, TX (US)

(21) Appl. No.: 13/215,866

(22) Filed: Aug. 23, 2011

Related U.S. Application Data
(60) Provisional application No. 61/375,915, filed on Aug. 23, 2010.

(51) Int. Cl. F26B 25/22; F26B 9/10; F26B 21/06

(52) U.S. Cl. 34/486; 34/526; 34/528; 34/218

(57) ABSTRACT

A drying system is provided. The drying system is configured to dry a person after the person exits a water feature. The drying system has a blower system configured to blow a gas proximate the person. The drying system has a controller system for operating the blower. The gas used in the drying system is configured to dry to the person after getting at least partially wet in the water feature.

### CROSS-REFERENCE TO RELATED APPLICATIONS

This application claims the benefit of U.S. Provisional Patent Application No. 61/375,915 filed Aug. 23, 2010. This related application is hereby incorporated by reference in its entirety.

### BACKGROUND

Embodiments of the inventive subject matter generally relate to field of drying people after swimming. More specifically, embodiments of the inventive subject matter generally relate to an air handler for blowing air at a person in order to dry the person.

Typically people exit a pool or hot tub and dry their bodies with a towel. They may dry themselves prior to entering their home, or other building proximate the pool. After drying themselves, the towels must be washed. There is a need for a more efficient way to dry after swimming.

### SUMMARY

Embodiments described herein comprise a drying system. The drying system may be configured to dry a person after exiting a water feature. The water feature may have a blower system configured to blow a gas proximate the person and a controller system for operating the blower. The gas may be configured to dry to the person after getting at least partially wet in the water feature. The water feature may be a pool, a hot tub, a splash pad, or any other suitable water feature. The blower system may be a turbine, or any other suitable blower system. The blower system may have ducting configured to channel the gas toward the person. The drying system may have a heating system configured to heat the gas prior to the gas engaging the person. The heating system may be one or more electric coils, a gas furnace, or any other suitable heating system configured to heat the gas. The dryer system may have a cooling system configured to cool the gas engaging the person. The cooling system may be an air conditioner, or any other suitable cooling system. The blower may be configured to be located proximate a structure and configured to dry the person prior to entering the structure. The blower system may be located at least partially under a deck, or within any suitable structure, and configured to blow the gas through the deck and onto the person. The deck may have a grating that the person can stand on. The blower system may be a stand alone unit that may be located about the water feature. The blower system may be located at least partially within an exterior wall of a structure proximate the water feature. The controller may a button, or any other suitable actuator, proximate the blower system for turning the blower system on. The controller system may have a timer configured to shut the blower system off after a suitable time has elapsed and wherein the suitable time is a typical dry time of the person. The controller system may have a moisture sensor configured to determine if the person is dry and wherein the controller system automatically shuts down the blower system when the person is dry. The controller system may have a proximity sensor configured to detect when the person is in front of the blower system.

Embodiments described herein comprise a method of drying a person after exiting a water feature. The method comprises exiting the water feature, actuating a drying system, blowing a gas past the person, and drying the person with the gas. The method may comprise actuating the drying system by pushing a button, standing on a grating or any, being detected by a sensor, other suitable actuation method. The method may comprise sensing a condition proximate the drying system. The method may comprise sensing a condition by detecting the air temperature. The method may comprise controlling a temperature of the gas based on the air temperature. The method may comprise treating the gas prior to engaging the person with the gas.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a schematic a drying system 100 according to an embodiment.

FIG. 2A depicts an embodiment of the blower system 102 according to an embodiment.

FIG. 2B depicts an embodiment of the blower system 102 according to an embodiment.

FIG. 3 depicts a method of using the dryer system 100 according to an embodiment.

### DESCRIPTION OF EMBODIMENT(S)

The description that follows includes exemplary apparatus, methods, techniques, and instruction sequences that embody techniques of the present inventive subject matter. However, it is understood that the described embodiments may be practiced without these specific details.

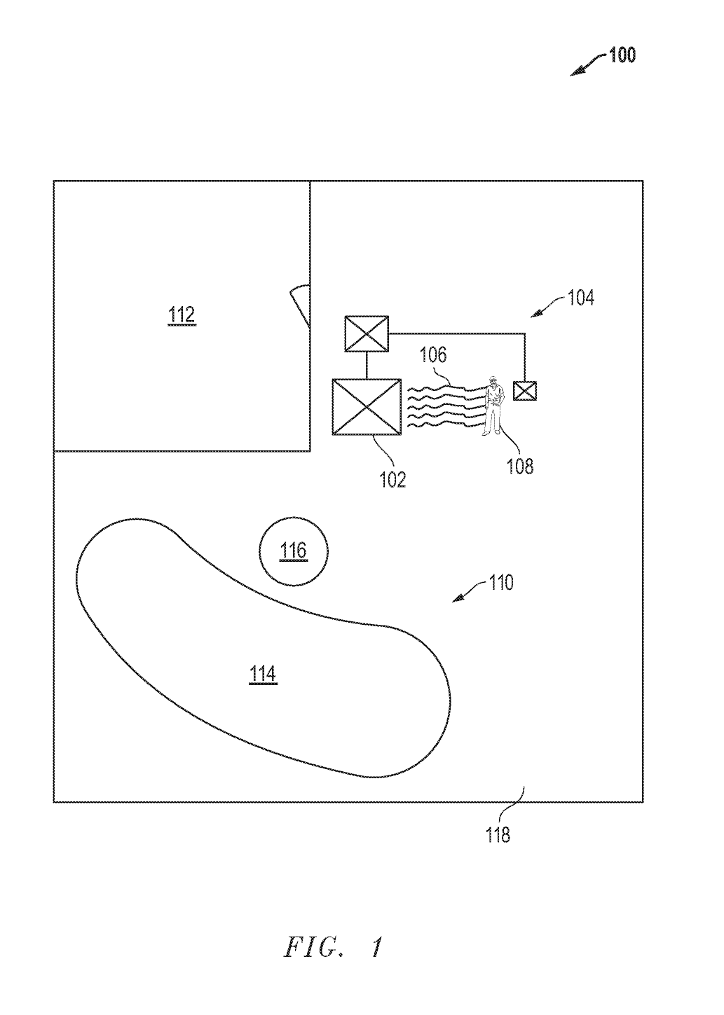

FIG. 1 depicts a schematic a drying system 100 according to an embodiment. The drying system 100 as shown has a blower system 102 (or dryer) and a control system 104. The blower system 102 may blow and/or push a gas 106 to a location proximate a person 108, and/or a plurality of people. The control system 104 may be configured to control the blower system 102. The blower system 102 may be located proximate one or more water features 110. The person 108 may get wet, or partially wet, in the water feature 110. Prior to entering a structure 112, or a vehicle (not shown), located proximate the water feature 110, the person may use the blower system 102 to blow the gas 106 near them. The gas 106 may substantially dry, or partially dry, the person prior to entering the structure 112. By drying with the drying system 100, the person 108 may alleviate the need to use towels to dry.

The one or more water features 110 as shown are a pool 114 and a hot tub 116 located in a backyard 118 of a residence. However, the one or more water features 110 are shown as the pool 114 and the hot tub 116, the one or more water features 110 may be any suitable water features including, but not limited to, a splash pad, a water slide, a lake, a river, a bayou, a sprinkler system, a spool, a community pool, an outdoor shower, and the like.

The structure 112 as shown is a house, or residence. However, the structure 112 may be any suitable structure for use proximate the one of more water features 110 including, but not limited to, a training center, a school, a recreation center, a restaurant, an office, a vehicle, and the like.

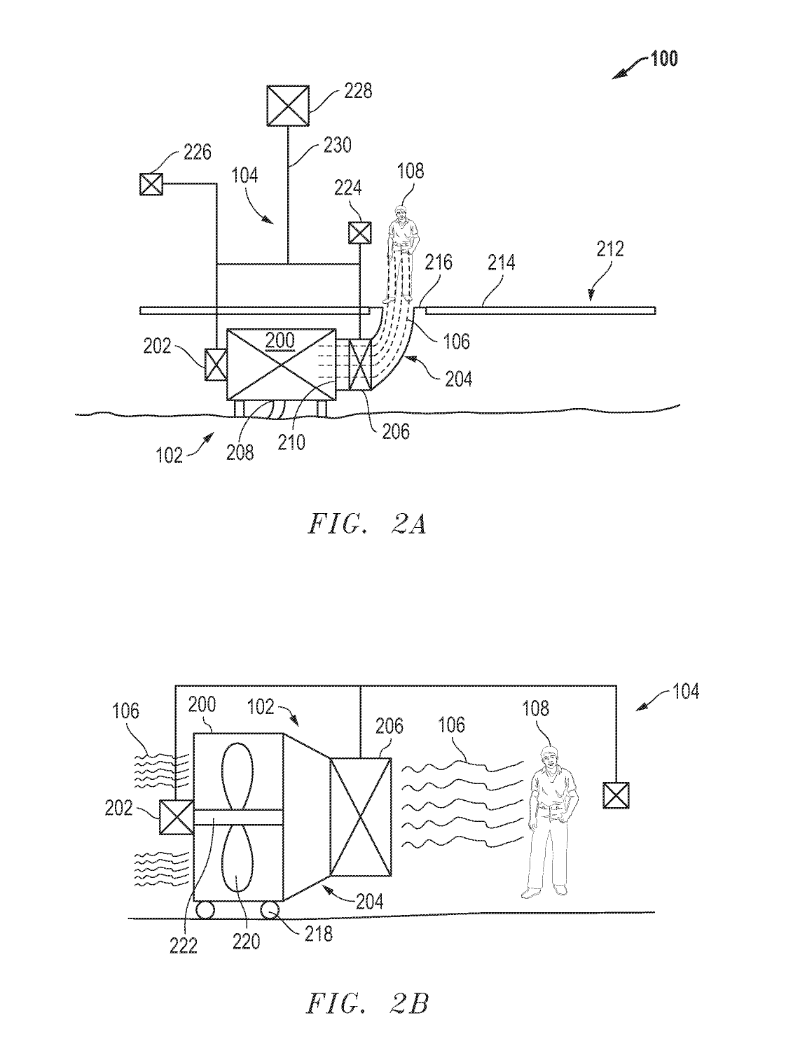

FIG. 2A depicts an embodiment of the blower system 102 according to an embodiment. The blower system 102 may have a gas mover 200, a motor 202, and a ducting system 204. Optionally, the blower system 102 may have a gas treatment system 206 located in the ducting system 204 and/or the gas mover 200.

The gas mover 200 may be configured to move the gas into the ducting system 204 and/or toward the person 108. The gas mover 200 may have an inlet 208 and an outlet 210. The inlet 208 may be in communication with a gas source and configured to pull, or suck, the gas 106 into the gas mover 200. The gas source may be the air around the gas mover 200, or another gas source including, but not limited to, a gas tank, treated air from an HVAC unit, purified gas, and the like. The outlet 210 may be in direct communication with the ducting system 204, or blow directly onto the person 108. The air mover 200 may be any suitable device for moving gas 106 including, but not limited to, a fan, a turbine, an air handler, a compressor, a pump, a blower, and the like.

As shown in FIG. 2A, the blower system 102 is located under a deck 212, or floor. At the deck 212 surface 214, a grating 216 may couple to the ducting system 204. The grating may allow the gas 106 to pass through the deck 212 while allowing the one or more persons 108 to stand on the deck 212 and/or the grating 216. By locating the blower system 102 under the deck 212, the blower system 102 may be substantially hidden from view. Although, the blower system 102 is shown located under the deck 212, it should be appreciated that the blower system 102 may be located at any suitable location proximate the one or more water features 110 including, but not limited to, in an exterior wall of the structure, or residence, within a portion or panel of a vehicle, and the like.

FIG. 2B depicts the blower system 102 as a free standing blower system unit that may be moved to any suitable location about the one or more water features 110. As shown, the blower system unit 102 may have one or more wheels 218 for rolling the blower system unit 102. Although shown as having wheels 218, there may any suitable mounting system including, but not limited to, legs, telescoping legs, an adjustable bracket for changing the angle or the blower system 102, and the like. The gas mover 200 as shown in FIG. 2B is a fan 220 driven by a drive shaft 222 coupled to the motor 202, although it may be any suitable gas mover 200 including those described herein.

The motor 202, as shown in FIGS. 2A and 2B, may be any suitable device for operating the air mover 200. The motor 202 may be a single speed motor configured to turn the air mover 200 on or off. In another embodiment, the motor 202 may be a variable speed configured to vary the speed on the gas mover 200. The speed of the gas mover 200 may be varied for any suitable reason including, but not limited to, saving power during start up, the moisture content of the person, the size of the person, the number of people, the outside air temperature, the humidity, and the like. The motor 202 may be an electric motor or any other suitable motor including, but not limited to, an air driven motor, a combustion engine, a diesel engine, and the like.

The ducting system 204 may direct the flow of the gas 106 from the gas mover 200 to the person 108. As shown in FIG. 2A, the ducting system is a ducting that couples the outlet 201, or exhaust, of the gas mover 200 to the grating 216. FIG. 2B depicts the ducting system 204 as a plume for channeling the gas 106 toward the person 108. The ducting system 204 may be any suitable ducting or delivery system including, but not limited to, a flexible ducting, an air sock, textile ducts, fiberglass duct board, sheet metal ducting, sheet metal piping, HVAC ducting, plumes, dampers, and the like.

The optional gas treatment system 206 may condition, or treat the gas 106 prior to the gas engaging the person 108. For example, the gas treatment system 206 may be a heater configured to heat the gas 106 prior to engaging the person 108. The heated gas may dry the person 108 faster than ambient air. Further, the heated gas may prevent the person 108 from becoming too cold after exiting the water feature 110, for example when exiting a hot tub in the winter. The heater may be any suitable heater for treating the gas. In an example, the heater has a heating element made of Nichrome that generates up to fifty (50) degrees above ambient air temperature. The gas 106 is blown over the heating element thereby transferring heat to the gas 106. Although the heating element is described as being Nichrome, it may be any suitable heating element, or heating system, for heating the gas including, but not limited to, metal coils, a gas heater, an electric heater, electric coils, a gas furnace, and the like.

In another example, the gas treatment system 206 may cool the gas 106. For example an AC unit, or misting unit, may cool the gas 106 prior to engaging the person 108. Although the gas treatment system 206 is described as heating or cooling the gas 106, it may perform any suitable treatment to the gas 106 including, but not limited to, purifying, ionizing, and the like.

Therefore the blower system 102 may be any suitable device for pushing the gas 106 toward the person 108. The blower system 102 may be configured to heat and/or dry the individual while the person 108 is drying. The blower system 102 may blow ambient air (or air at the outside, or room temperature), or heated air at the person 108 while drying the person 108. If the blower system 102 is blowing ambient air, it may be configured to simply dry the person prior to leaving the water feature 110. If the blower system 102 is blowing heated air, it may be configured to warm and dry the person 108 prior to leaving the water feature 110. The blower system 102 may further be configured to blow cool (or air conditioned air) at the person, for example, to cool a person after finishing exercise or yard work. Further still, the blower system 102 may have the capacity to switch between cooling and/or heating the person 108 based on the temperature outside, and/or the type of tasks the person 108 was performing.

The gas 106 may be any suitable gas for drying the person 108. Typically the gas 106 is air. However, the gas 106 may be any suitable gas for drying the person 108 including, but not limited to oxygen, a gas mixture substantially comprised of oxygen, carbon dioxide, and the like.

The control system 104 may be configured to operate the gas mover 200 and thereby dry the person 108. The control system 104 may have an actuator 224, one or more sensors 226, one or more controllers 228 and one or more communication links 230. The communication links 230 may be any suitable communication link for communicating between the components of the drying system 100. As shown the communication links 230 are wired connections, although the communication links 230 may be any suitable communication connection including, but not limited to, wireless connections, fiber optic connections, infrared connections, acoustic connections, optical connections, and the like.

The actuator 224 may be any suitable device for actuating the motor 202 and thereby the gas mover 200. The actuator 224 may be a button that the person 108 pushes in an example. The button may be activated by the hand, the foot, and/or any other suitable body part of the person 108. For example, the button may be a foot pedal, or button in an embodiment. Further, the button may be couple to the gating 216. In this example, if the person 108 stands on the grating 216 the gas will be pushed past the person 108. In another embodiment, the actuator 224 may be a sensor configured to detect the presence of the person 108. The actuator 224 sensor may be any suitable sensor for detecting the presence of the person 108 including, but not limited to, an infrared sensor, a motion detector, a strain gauge, an optical sensor, moisture detector, a thermal sensor, and the like. If the person 108 is detected by the sensor 226, the gas mover 200 may by automatically turned on by the control system 104.

The one or more sensor(s) 226 may be any suitable sensor for detecting conditions about the dryer system 100. The one or more sensor(s) 226 may include, but are not limited to, an infrared sensor, a motion detector, a strain gauge, an optical sensor, moisture detector, a thermal sensor, a thermometer, a barometer, and the like. The one or more sensor(s) 226 may send data and/or instructions to the motor 202, the gas treatment system 206 and the like.

The controller 228 may collect, store, and/or manipulate the data sent via the communication links 230 from the actuator 224 and/or the sensor 226 in order to determine the proper operation of the blower system 102. For example, if the person 108 activates the actuator 224 (such as by pushing a button), the controller 228 may activate the motor 202. Optionally the controller 228 may control the time and/or the speed of the motor 202. In another example, the one or more sensors(s) 226 may detect the air temperature, or other environmental conditions, about the dryer system. This temperature data may be sent to the controller 228. The controller 228 may then determine the appropriate treatment to the gas 106 exiting the blower system 102. When a person 108 actuates the actuator 224, the controller 228 may actuate the motor 202 for the appropriate time and speed. In addition, the controller 228 may determine the need to treat the gas 106 with the gas treatment system 206. For example, if the air temperature is cold, the controller 228 may activate the gas treatment system 206 to heat the gas 106. Further, the sensors 226 may continuously detect the moisture of the person 108. When the moisture falls below a certain fixed level, the controller 228 may instruct the motor 202 to shut down.

The controller 228 may be any suitable device for storing, processing, sending, receiving and/or manipulating data about the dryer system 100. In an embodiment, the controller 228 is a computer. However, it should be understood that the controller 228 may be any suitable device capable of controlling the dryer system 100.

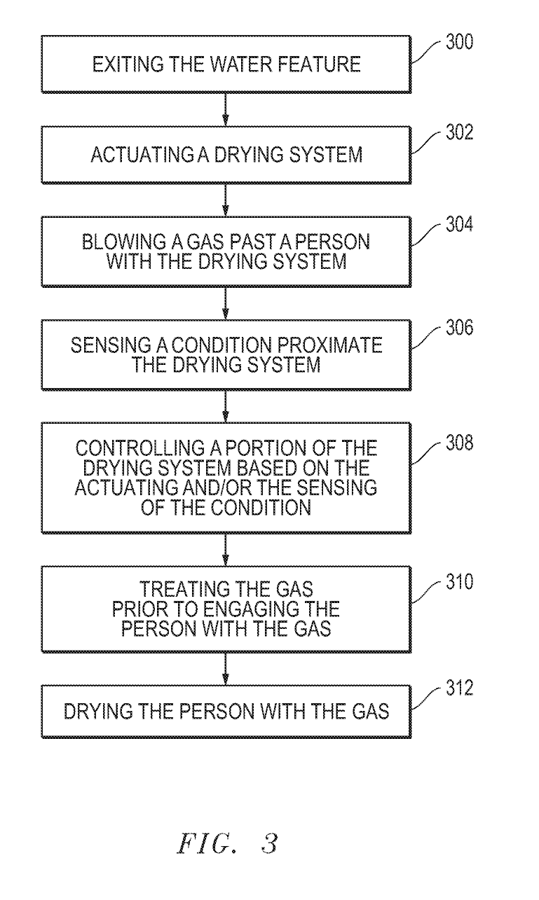

FIG. 3 depicts a flow diagram of a method of using the dryer system. The flow begins at block 300 wherein a person exits a water feature. The flow continues at block 302 wherein a drying system 100, and/or the blower system 102 is actuated. The flow continues at block 304 wherein a gas is blown past the person with the drying system. The flow optionally continues at block 306 wherein a condition is sensed proximate the drying system. The flow optionally continues at block 308 wherein a portion of the drying system is controlled based on the actuation of the drying system and/or the sensing of the condition. The flow optionally continues at block 310 wherein the gas is treated with the treatment system 206 prior to engaging the person with the gas 106. The flow continues at block 312 where the person is dried.

While the embodiments are described with reference to various implementations and exploitations, it will be understood that these embodiments are illustrative and that the scope of the inventive subject matter is not limited to them. Many variations, modifications, additions and improvements are possible. For example, the techniques used herein may be applied to any drying system of persons and/or animals using any recreational facility such as the ocean, a lake, snow, and the like.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A drying system configured to dry a person after exiting a water feature, comprising:
a blower system configured to blow a gas proximate the person;
a controller system for operating the blower; and
wherein the gas is configured to dry to the person after getting at least partially wet in the water feature.

2. The drying system of claim 1, wherein the water feature is a pool.

3. The drying system of claim 1, wherein the water feature is a hot tub.

4. The drying system of claim 1, wherein the blower system further comprises a fan.

5. The drying system of claim 1, wherein the blower system further comprises a turbine.

6. The drying system of claim 1, wherein the blower system further comprises ducting configured to channel the gas toward the person.

7. The drying system of claim 1, further comprising a heating system configured to heat the gas prior to the gas engaging the person.

8. The drying system of claim 1, further comprising a cooling system configured to cool the gas engaging the person.

10. The drying system of claim 1, wherein the blower is configured to be located proximate a structure and configured to dry the person prior to entering the structure.

11. The drying system of claim 1, wherein blower system is located at least partially under a deck and configured to blow the gas through the deck and onto the person and wherein the deck has a grating that the person can stand on.

12. The drying system of claim 1, wherein the blower system is a stand alone unit that may be located about the water feature.

13. The drying system of claim 1, wherein the controller system further comprising a timer configured to shut the blower system off after a suitable time has elapsed and wherein the suitable time is a typical dry time of the person.

14. The drying system of claim 1, wherein the controller system further comprises a moisture sensor configured to determine if the person is dry and wherein the controller system automatically shuts down the blower system when the person is dry.

15. The drying system of claim 1, wherein the controller system further comprises a proximity sensor configured to detect when the person is in front of the blower system.

16. A method of drying a person after exiting a water feature, the method
comprising:
exiting the water feature;
actuating a drying system;
blowing a gas past the person; and
drying the person with the gas.

17. The method of claim 16, further comprising entering a structure substantially dry.

18. The method of claim 16, further comprising sensing a condition proximate the drying system.

19. The method of claim 18, wherein sensing a condition further comprises detecting the air temperature and controlling a temperature of the gas based on the air temperature.

20. The method of claim 16, wherein actuating the drying system further comprises standing on a grating.
